(19) United States
(12) Patent Application Publication
(10) Pub. No.: US 2004/0137789 A1
(43) Pub. Date: Jul. 15, 2004

(54) Device for connecting coaxial conductors to a plug-in connector

(76) Inventors: Franz Feuerreiter, Bad Tolz (DE); Anton Schrocker, Munchen (DE)

Correspondence Address: BELL, BOYD & LLOYD, LLC, P. O. BOX 1135, CHICAGO, IL, 60690-1135, US

(21) Appl. No.: 10/476,940

(22) PCT Filed: Apr. 15, 2002
(86) PCT No.: PCT/DE02/01401

(30) Foreign Application Priority Data
May 4, 2001 (DE) 101 21 762.5

(51) Int. Cl. H01R 9/05

(52) U.S. Cl. 439/578

(57) ABSTRACT

The invention relates to a shielded plug-in connector (1), provided with a shield housing (2), on which a cylindrical crimp sleeve (3) is formed. A substantially cylindrical moulded part (4) has partial cylindrical longitudinal grooves (5), into which the exposed shield jackets (7) of coaxial conductors (6) can be inserted. The moulded part (4) can be introduced, together with the coaxial conductors (6) into the crimp sleeve (3). The latter is compressed using a serrated crimping tool, whereby the moulded part (4) is deformed in such a way that the longitudinal grooves (5) contract and the shield jackets (7) are tightly encompassed.

The invention relates to a plug-in connector for connecting coaxial conductors in which shield jackets of the coaxial connector can be connected to surrounding grounded crimp contacts of the plug-in connector.

This type of device has become known for example through EP 0 793 296 A2. According to this a multiway plug-in connector features a ground contact which is provided with crimp tabs at the rear, into which the end sections of the coaxial conductors with exposed shield jackets can be inserted. The plug-in connector is further provided with a grounded shield housing.

Furthermore, WO 9312561 Al shows a plug-in connector for coaxial conductors with shield jackets exposed in an end section. The back of the plug-in connector features a conducting molded part with longitudinal grooves which in cross section are partly circular, to each accommodate one of the exposed end sections of the coaxial conductor. These can alternately be secured by a cable tie or by means of two rigid housing sections to be screwed together (140, 142) to further housing sections formed on them (150, 152)

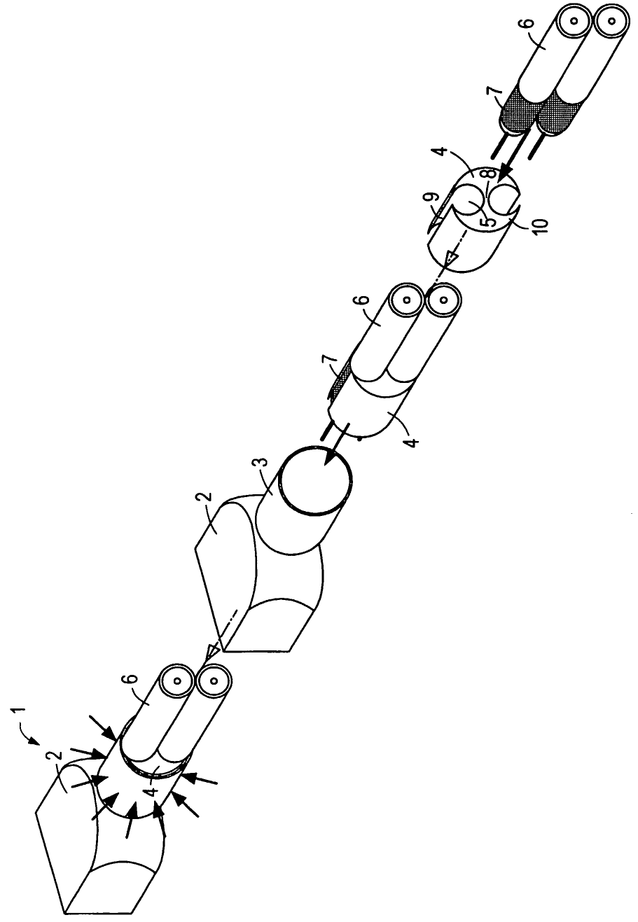

Furthermore EP 0902502 Al (FIGS. 3, 7) discloses a plug-in connector for connecting a coaxial conductor with a shield jacket. In the area where the cable is introduced into it, the plug-in connector features a crimp sleeve (62) which is rigidly connected to the crimp housing (60). A metallic molded part can be used in the crimp sleeve and, in conjunction with the latter, forms a crimp contact. The shield jacket of the coaxial cable is not exposed however.

The underlying object of the invention is to simplify contacting of the shield jacket and improve the shielding effect.

This object is achieved by the invention in accordance with claim 1. The molded part is designed in such a way that it largely surrounds the individual end sections so that there is resulting contact with the molded part over a large area. The longitudinal groove opening can be kept narrow enough for the crimp sleeves of the shield jacket to make good contact but to still protect them against too much deformation. It goes without saying that the groove cross section does not have to be exactly circular but can also very often be polygonal or slightly elliptic. The only important aspect is that after the molded part is pressed together a secure all-around contact is established with the matching end section. The crimp sleeve can be designed in such a way that after crimping it is tight against the for example extruded or molded part. In this way not only is the strain on the individual coaxial conductors in the insertion area of the plug-in connector securely relieved, but they are also given a high-frequency proof ground connection.

Advantageous embodiments of the invention in accordance with claims 2 and 3 allow the molded part to be deformed so that with round crimping the crimp sleeve lies securely against the end section, enabling crimping to be undertaken with a manual crimping tool.

The development in accordance with claim 4 produces a direct high-frequency proof connection between the shield jacket, the molded part und the shield housing.

The invention is explained below in more detail using one of the exemplary embodiments shown in the drawing.

The Figure illustrated shows in a perspective exploded view a plug-in connector 1 with connected coaxial conductor 6. The plug-in connector 1 features a surrounding shield housing 2 which is molded into the insertion area of coaxial conductor 6 into a cylindrical crimp sleeve 3. A largely cylindrical molded part is inserted into this which is provided with partly cylindrical lengthwise grooves 5. These are arranged so that between them in the central area there remains a narrow divider 8 and so that they intersect with the external jacket of molded part 4 to form a narrow longitudinal slot 9. Between the longitudinal slot 5 and the outside jacket of molded part 4 wing-shaped tapered protrusions 10 are formed.

With coaxial conductors 6 a shield jacket 7 is exposed in an end section. The diameter of the longitudinal grooves 5 is, prior to assembly, somewhat larger than the external diameter of shield jacket 7. These are pushed into the longitudinal grooves in the direction of the arrow and inserted along with the molded part 4 into the crimp sleeve 3. Then the crimp sleeve 3 is pressed together in the direction of the star arrangement of arrows in the left-hand part of the picture firmly enough for the molded part 4 to deform. When this is done the protrusions 10 bend inwards so that the longitudinal grooves 5 narrow. Furthermore the divider 8 is kept thin enough to be compressed at high crimping force and the longitudinal grooves narrow further. The shield jacket 7 is thus firmly gripped all around and contacted with the body of the shield housing. With an expanded crimp sleeve it is also possible to provide the enlarged molded part with more than two longitudinal grooves for a larger number of coaxial connectors.

1. Plug-in connector (1) for connecting coaxial conductors (6), with the exposed shield jacket (7) of end sections of the coaxial conductor (6) able to be connected with surrounding grounded crimp contacts of the plug-in connector (1) and with the plug-in connector (1) being provided with a shielding housing (2),
characterized in that, the plug-in connector (1) features a metallic crimp sleeve (3) in the cable entry area which is rigidly connected to the shield housing (2),
that a metallic molded part (4) can be used in the crimp sleeve (3) which forms the crimp contacts in conjunction with the latter,
that the molded part (4) in cross section features partly circular longitudinal grooves (5) to each accept one of the exposed end sections of the coaxial conductor (6) and that the crimp sleeve (3) can be compressed to an extent where the longitudinal grooves (5) of the molded part (4) narrow.

2. Plug-in connector according to claim 1, characterized in that the molded part (4) features wing-shaped protrusions (10) between its part cylindrical external jacket and the longitudinal grooves (5) which can be bent inwards by the crimp sleeve (3).

3. Plug-in connector according to claim 1 or 2, characterized in that the longitudinal grooves (5) are evenly distributed over the circumference of the molded part (4) and a remaining divider (8) between the longitudinal grooves (5) can be deformed by the crimp sleeve (3), especially squashed.

4. Plug-in connector according to claim 1, 2 or 3, characterized in that the crimp sleeve (3) is a one-piece element of the shield jacket (2) surrounding the plug-in connector (1).
